(19) United States
(12) Patent Application Publication
(10) Pub. No.: US 2009/0097284 A1
(43) Pub. Date: Apr. 16, 2009

(54) SWITCHING POWER SUPPLY

(75) Inventors: Tomoaki Takei, Kyoto (JP); Tetsuji Yamashita, Kyoto (JP); Kazuhiro Murata, Osaka (JP); Yoshihiro Mori, Kyoto (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 12/239,931

(22) Filed: Sep. 29, 2008

(30) Foreign Application Priority Data
Oct. 15, 2007 (JP) 2007-267313

(51) Int. Cl. H02H 7/122

(52) U.S. Cl. 363/56.1

(57) ABSTRACT

In the present invention, an on time is used which increases at an instantaneous interruption. The on time is detected by a MAX-DUTY detector 10 and the overload protection function of an overload protection circuit 150 is disabled.

### FIELD OF THE INVENTION

The present invention relates to a switching power supply which is a power supply having a protective function against an overloaded state such as a load short-circuit.

### BACKGROUND OF THE INVENTION

Conventionally, as power supplies of various home appliances including home electrical appliances, switching power supplies with small sizes, light weights, and high efficiency have been widely used which control output voltages and so on by using the switching operations of switching elements. Such switching power supplies have played an important role in supplying power to various home appliances.

Generally, in such a switching power supply, when an abnormality such as a short circuit occurs on a load side or the output side of the switching power supply, it is necessary to sufficiently reduce power supplied from the input side to the load side to protect the load side and the switching power supply. As a method of reducing power supply, a fuse may be provided on the output stage of the load side. In this case, the fuse blows in an overloaded state and thus even when the load side recovers to a normal state after that, the power supply cannot be operated again until the fuse is replaced.

Another method not using a fuse is available. In this method, an overload protection circuit is disposed which can detect an overloaded state in a power supply circuit and sufficiently suppress power supply from an input side to a load side.

Such an overload protection circuit includes a latch-type circuit which is kept, once a protecting operation is performed, in a protection state until a predetermined reset signal is inputted, and a self-reset type circuit which automatically resets a protecting operation state when recovering from an overloaded state to a normal state, and then returns to a normal operation.

Referring to the simplified drawing of FIG. 9, the following will first describe a prior art example of a switching power supply having a latch-type overcurrent protection circuit whose operations are similar to those of the above-described overload protection circuit.

FIG. 9 is a circuit diagram showing an example of a semiconductor device used for controlling a switching power supply in the prior art. A semiconductor device 201 for controlling a switching power supply in FIG. 9 includes, for example, a switching element 101 such as a metal oxide semiconductor field effect transistor (MOSFET) and a control circuit for controlling the switching operation of the switching element 101. The semiconductor device 201 is made up of three terminals of a high voltage terminal (DRAIN terminal) and a GND terminal (SOURCE terminal) of the switching element 101 and a control terminal (CONTROL terminal) for inputting a control signal.

In FIG. 9, reference numeral 102 denotes an error amplifier fed with, as a negative input, a power supply voltage VCC of the semiconductor device 201 for controlling the switching power supply. The positive input terminal of the error amplifier 102 is fed with a predetermined reference voltage, and the error amplifier 102 outputs an error voltage signal VEAO, which is obtained by comparing the inputted power supply voltage VCC and the reference voltage, as the positive input of a comparator 103 for drain current detection.

The negative input of the comparator 103 for drain current detection is fed with a detected voltage VCL outputted from a drain current detection circuit 104 connected to the drain of the switching element 101. The drain current detection circuit 104 detects a current passing through the switching element 101, converts the detected current to a voltage signal, and outputs the signal as the detected voltage VCL.

The comparator 103 for drain current detection compares the detected signal VCL, which corresponds to the current passing through the switching element 101, and the error voltage signal VEAO. The comparator 103 for drain current detection is so connected as to output an output signal to the reset (R) terminal of an RS flip-flop circuit 105 when the detected signal VCL and the error voltage signal VEAO are equal to each other.

The error voltage signal VEAO outputted from the error amplifier 102 has the maximum value fixed by an overcurrent protection circuit 106. The overcurrent protection circuit 106 prevents an overcurrent from passing through the switching element 101.

An oscillator 107 outputs a clock signal 108 for determining the switching frequency of the switching element 101 and a maximum on-duty cycle signal 109 for determining the maximum on-duty cycle of the switching element 101. The clock signal 108 outputted from the oscillator 107 is supplied to the set (S) terminal of the RS flip-flop circuit 105, and an output (Q) of the RS flip-flop circuit 105 is outputted to a NAND circuit 110. The maximum on-duty cycle signal 109 outputted from the oscillator 107 is directly inputted to the NAND circuit 110.

To the drain terminal of the switching element 101, an internal circuit current supply circuit 111 for supplying power supply current is connected as a circuit for supplying the internal power of the semiconductor device 201 for controlling the switching power supply. The internal circuit current supply circuit 111 is caused to supply power to an internal circuit at power-on by a start/stop circuit 112 which controls the start and stop of the semiconductor device 201 for controlling the switching power supply. The output of the start/stop circuit 112 is also inputted to the NAND circuit 110.

An overload protection circuit 155 is made up of at least an overload detection circuit 113 for detecting an overloaded state, a restart trigger 115 acting as a device for resetting an overloaded state when the overloaded state is detected, and an RS flip-flop circuit 114 which is a latched circuit acting as a switching operation stop circuit for stopping the switching operation of the switching element 101. The overload detection circuit 113 is connected to a power supply voltage VCC line of the semiconductor device 201 for controlling the switching power supply and is so connected as to output a signal to the set (S) terminal of the RS flip-flop circuit 114 when the power supply voltage VCC decreases to a predetermined voltage.

The restart trigger 115 is connected to the power supply voltage VCC line of the semiconductor device 201 for controlling the switching power supply, and the restart trigger 115 outputs a signal to the reset terminal of the RS flip-flop circuit 114 when the power supply voltage VCC falls to the predetermined voltage or lower during overload protection. The RS flip-flop circuit 114 outputs a signal to the NAND circuit 110.

The NAND circuit 110 is fed with four signals of the output signal of the RS flip-flop circuit 105, the maximum on-duty cycle signal 109 of the switching element 101 from the oscillator 107, a signal outputted from the start/stop circuit 112, and the output signal of the RS flip-flop circuit 114. The output of the NAND circuit 110 is supplied to a drive circuit (gate driver) 116 of the switching element 101 as a switching control signal of the switching element 101. The drive circuit 116 controls the switching operation of the switching element 101 based on the supplied switching control signal.

An example of the switching power supply of the prior art is illustrated by a circuit diagram in which the semiconductor device 201 for controlling the switching power supply in FIG. 9 replaces a semiconductor device 202 for controlling a switching power supply shown in the circuit diagram of FIG. 2. This configuration will be described below.

In the switching power supply, a commercial AC power supply is rectified by a rectifier 120 such as a diode bridge and is smoothed by an input capacitor 121, so that a DC voltage VIN is obtained. A transformer 122 serving as an inductance component for transmitting energy from an input side to a load side is made up of a first primary winding 122a, a second primary winding 122b, and a secondary winding 122c. The DC voltage VIN is applied to the first primary winding 122a.

The DC power supplied to the first primary winding 122a of the transformer 122 is transmitted from the first primary winding 122a of the transformer 122 to the secondary winding 122c by the switching operation of the switching element 101.

The power transmitted to the secondary winding 122c of the transformer 122 is rectified and smoothed by a diode 123 and a capacitor 124 which are connected to the secondary winding 122c, and the power is supplied to a load 125 as the DC power of an output voltage VO.

The DC power outputted from the first primary winding 122a is transmitted also to the second primary winding 122b of the transformer 122 and is outputted from the second primary winding 122b. The second primary winding 122b is connected such that the DC power is rectified and smoothed by a diode 126 and a capacitor 127 which are auxiliary power supplies. Further, an auxiliary power supply voltage VCC outputted from an auxiliary power supply part is inputted to the control terminal (CONTROL terminal) of the semiconductor device 201 for controlling the switching power supply and is used as a power supply voltage of the semiconductor device 201 for controlling the switching power supply. The power supply voltage VCC is proportionate to the output voltage VO supplied from the secondary winding 122c of the transformer 122 to the load 125, and is used as a feedback signal for stabilizing the output voltage VO.

The operations of the switching power supply configured thus will be described below.

When an AC power from a commercial power supply is inputted to the rectifier 120, the AC power is rectified and smoothed by the rectifier 120 and the capacitor 121 and is converted to the DC voltage VIN. The DC voltage VIN is applied to the first primary winding 122a of the transformer 122. Further, the DC voltage VIN charges the capacitor 127 for the power supply voltage VCC through the internal circuit current supply circuit 111 in the semiconductor device 201 for controlling the switching power supply.

After that, when the power supply voltage VCC reaches a starting voltage set by the start/stop circuit 112 in the semiconductor device 201 for controlling the switching power supply, the internal circuit is started and the control of the switching operation of the switching element 101 is started. At the same time, the start/stop circuit 112 stops the internal circuit current supply circuit 111, and the internal circuit current of the semiconductor device 201 for controlling the switching power supply is supplied through the second primary winding 122b of the transformer 122.

The semiconductor device 201 for controlling the switching power supply controls the switching operation of the switching element 101 based on the power supply voltage VCC so as to stabilize the output voltage VO to the load 125 at a predetermined voltage. The output voltage VO to the load 125 and the power supply voltage VCC are proportionate to the turns ratio of the second primary winding 122b and the secondary winding 122c of the transformer 122.

To be specific, as shown in the timing charts of FIG. 10, when a current supply to the load 125 decreases, the load 125 being connected to the output part of the switching power supply of the prior art, a decrease in current supply to the load 125 (FIG. 10(A)) increases the output voltage VO to the load 125 (FIG. 10(B)), increases the power supply voltage VCC accordingly (FIG. 10(C)), and reduces the output voltage VEAO of the error amplifier 102 (FIG. 10(D)).

When the output voltage VEAO of the error amplifier 102 and the current detection voltage VCL passing through the switching element 101 are equal to each other, a reset signal is outputted from the comparator 103 for drain current detection to the reset terminal of the RS flip-flop circuit 105. Thus a signal for turning off the switching element 101 is outputted from the NAND circuit 110. Consequently, the on time of the switching element 101 is shortened in switching control, and a current ID passing through the switching element 101 decreases (FIG. 10(E)).

As has been discussed, the semiconductor device 201 for controlling the switching power supply during a normal operation is operated in a current mode control system in which the magnitude of a current passing through the switching element 101 is controlled according to a current supplied to the load 125 which is connected to the output part of the switching power supply of the prior art.

Next, referring to the timing charts of FIG. 11, the following will describe operations in a so-called overloaded state such as a short circuit on the load side and a short circuit on the output side of the switching power supply.

In the latch-type overload protection circuit, a decrease in the power supply voltage VCC of the semiconductor device 201 for controlling the switching power supply is detected by a control circuit voltage detector according to operations that will be described below, and then the switching operation of the switching element 101 is stopped, so that protection is achieved.

The operations at this point will be described below.

The output voltage VO decreases in an overloaded state (FIG. 11(A)) and the power supply voltage VCC starts decreasing accordingly.

Next, when the power supply voltage VCC decreases to VCC(OFF), an output voltage VCH of the start/stop circuit 112 is inverted and charges the capacitor 127 for the auxiliary power supply voltage VCC through the internal circuit current supply circuit 111, and then the power supply voltage VCC increases to VCC(ON) again. Once the power supply voltage VCC increases to VCC(ON), the output voltage VCH of the start/stop circuit 112 is inverted again, and charged current through the internal circuit current supply circuit 111 is cut off. In this way, the power supply voltage VCC is repeatedly reduced and increased thereafter (FIGS. 11(B) and 11(C)).

When the power supply voltage VCC decreases to VCC(OFF), an output voltage VDET of the overload detection circuit 113 is inverted, a set signal is outputted to the set terminal of the RS flip-flop circuit 114 (FIG. 11(D)), and a signal for turning off the switching element 101 is outputted from the RS flip-flop circuit 114 having received the set signal. Consequently, the switching element 101 is in a stopped state in which switching is not performed (FIG. 11(E)). By stopping power supply from a primary side to the load side, it is possible to achieve protection from an overloaded state in the event of a short circuit on the load and a short circuit on the output side of the switching power supply.

Further, when cancelling the protecting operation in the latched state, it is necessary to reduce the power supply voltage VCC inputted to the restart trigger 115 to a latch reset voltage VCC (RES), and input a reset signal from the restart trigger 115 to the reset (R) terminal of the RS flip-flop circuit 114. In this case, the latch reset voltage VCC(RES) is set at a smaller value than VCC(OFF). During overload protection, in the operation of FIG. 11(B) where the input voltage VIN is at least a predetermined voltage and the power supply voltage VCC fluctuates between VCC(OFF) and VCC(ON), the power supply voltage VCC does not fall below VCC(OFF), so that the overload protection state is not reset.

Thus in order to recover the power supply from the overload protection state to a normal state, it is necessary to drop the input voltage VIN once.

In such a latch-type overload protection circuit (for example, see Japanese Patent Laid-Open No. 9-182277), it is possible to achieve protection from an overloaded state such as a short circuit on a load without using a fuse and the like. When the overloaded state is reset, a power supply can be restarted by shutting down the power supply once.

On the other hand, so-called self-reset overload protection is generally used in which protection is automatically reset when a power supply is recovered from an overload protection state, unlike latch-type overload protection.

In a self-reset type overload protection circuit (see FIG. 12), a control circuit voltage detector detects a decrease in power supply voltage VCC of a semiconductor device 301 for controlling a switching power supply, according to operations that will be described below. By making the switching period of a switching element 101 shorter than the switching period of a normal state, it is possible to suppress power supply to a load side and so on and achieve overload protection. Further, when an overloaded state is reset, the reset is detected and a power supply can be restored to a normal operation.

FIG. 12 is a circuit diagram showing an example of the semiconductor device for controlling a switching power supply with a self-reset overload protection function. In FIG. 12, the same constituent elements as the semiconductor device for controlling the switching power supply in FIG. 9 are indicated by the same reference numerals and the explanation thereof is omitted.

The semiconductor device is different from the semiconductor device for controlling the switching power supply with the latch-type overload protection function of the prior art in that the latch-type overload protection circuit 155 including the overload detection circuit 113, the RS flip-flop circuit 114, and the restart trigger 115 is removed and an overload protection circuit 156 including a comparator 117 connected to a power supply voltage VCC line and a timer intermittent operation circuit 118 is disposed instead of the overload protection circuit 155.

In other words, the self-reset overload protection function is different from the latch-type overload protection function of the prior art in that the comparator 117 is used as an overload protection detector and the timer intermittent operation circuit 118 is used as a switching operation stop circuit for suppressing the switching operation of the switching element 101. The timer intermittent operation circuit 118 includes a reset terminal and is used as a device for resetting an overload protection state.

The comparator 117 has a positive input fed with a power supply voltage VCC and a negative input fed with a starting voltage VCC(ON) in a period during which the power supply voltage VCC increases to VCC(ON). The negative input is fed with a stop voltage VCC(OFF) in a period during which the power voltage decreases from VCC(ON) to VCC(OFF).

The comparator 117 is so connected as to output a signal to the timer intermittent operation circuit 118 when the power supply voltage VCC temporarily increases to VCC(ON) and then decreases to VCC (OFF). The timer intermittent operation circuit 118 is disposed so as to count output signals from the comparator 117 and output a signal to a NAND circuit 110 every predetermined number of counts.

In a switching power supply of the prior art using the semiconductor device for controlling the switching power supply in FIG. 12, the semiconductor device 202 for controlling the switching power supply in FIG. 2 is replaced with the semiconductor device 301 for controlling the switching power supply in FIG. 12.

Referring to the timing charts of FIG. 13, the following will describe operations in the event of an overloaded state such as a short circuit in the switching power supply configured thus. The operations during overload protection are different from the operations of the semiconductor device for controlling the switching power supply in FIG. 9 with the latch-type overload protection function.

First, an output voltage VO decreases in an overloaded state (FIG. 13(A)) and the power supply voltage VCC proportionate to the output voltage VO starts decreasing. When the power supply voltage VCC decreases to VCC(OFF), an output voltage VCH of a start/stop circuit 112 is inverted and charges a capacitor 127 for an auxiliary power supply voltage VCC through an internal circuit current supply circuit 111, and the power supply voltage VCC increases to VCC(ON) again.

Once the power supply voltage VCC increases to VCC(ON), the output voltage VCH of the start/stop circuit 112 is inverted again, and charged current through the internal circuit current supply circuit 111 is cut off. In this way, the power supply voltage VCC is repeatedly reduced and increased thereafter (FIGS. 13(B) and 13(C)).

Further, the comparator 117 outputs a pulse signal to the timer intermittent operation circuit 118 every time the power supply voltage VCC decreases from VCC(ON) to VCC(OFF) (FIG. 13(D)).

When receiving the signal from the comparator 117, an output voltage VTI from the timer intermittent operation circuit 118 is inverted and a signal for stopping the switching operation of the switching element 101 is outputted. After that, every time the power supply voltage VCC decreases from VCC(ON) to VCC(OFF), a counter included in the timer intermittent operation circuit 118 stores the number of inputs of signals from the comparator 117.

When the number of counts exceeds a predetermined number of times thereafter and the power supply voltage VCC reaches VCC(ON) again, a signal for restarting the switching operation of the switching element 101 is outputted from the timer intermittent operation circuit 118 and the switching element 101 performs the switching operation until the power supply voltage VCC decreases to VCC(OFF) (FIGS. 13(E) and 13(F)). At this point, when the overloaded state is not reset, the output voltage VO stays low and thus the power supply voltage VCC is repeatedly reduced and increased again.

When the overloaded state is reset, energy is supplied to a load side in a period during which the switching element 101 performs the switching operation, so that the output voltage VO increases again. Thus the power supply voltage VCC does not decrease to VCC(OFF) and the power supply can recover from an overload protection state to a normal power supply operation.

In such a self-reset overload protection circuit (for example, see Japanese Patent Laid-Open No. 2000-324817), overload protection is achieved by shortening the switching time of the switching element in the event of a short circuit on a load side or a short circuit on the output side of the switching power supply. When an overloaded state is reset, the power supply can automatically recover to a normal operation.

In the switching power supply of the prior art, however, overload protection is enabled in a so-called instantaneous interruption, for example, an instantaneous decrease in input voltage because of an instantaneous power failure, so that the power supply may be started in a stopped state or the start of the power supply may be delayed.

The following will specifically describe the foregoing problem regarding the latch type and the self-reset type.

First, VOR applied to the first primary winding 122a of the transformer is generally called a reflector voltage and is expressed, when the switching element is turned off, as follows:

VOR=Ns/Np×VO (1)

where Np represents a winding number of the first primary winding 122a, Ns represents a winding number of the secondary winding 122c, and VO represents an output voltage. Next, an on-duty cycle DON which is a ratio of the on time of the switching element 101 is expressed as below:

DON=VOR/(VIN+VOR) (2)

where VIN represents an input voltage and VOR represents a reflector voltage. The on voltage of the switching element is smaller than other voltages and thus is ignored.

In a power supply of pulse-width-modulation (PWM) control in which a switching operation is repeated at a constant frequency as in the prior art, a maximum on-duty cycle DONmax is generally set to prevent heat and a break, which are caused by excessive power supply from an input side or an increased on time of a switching element in the event of an abnormality, so that a value exceeding the maximum on-duty cycle DONmax is not set.

Next, in an operation during an instantaneous interruption, power supply from the input side is instantaneously cut off and thus the input voltage VIN gradually decreases. Further, from when the input voltage VIN starts decreasing to when the input voltage VIN comes close to zero, power can be supplied from the input side to the output side. Thus the output voltage VO does not decrease for a while. In other words, immediately after the instantaneous interruption, the input voltage VIN decreases but the output voltage VO may not decrease.

In this state, the input voltage VIN decreases and the output voltage VO (∝ reflector voltage VOR) does not change. Thus the on-duty cycle DON gradually increases with a reduction in input voltage according to Formulas (1) and (2), and finally increases to the maximum on-duty cycle DONmax. Since the on duty cannot have a value exceeding the maximum on-duty cycle thereafter, power required from the load side cannot be supplied and the output voltage VO starts gradually decreasing.

In the configuration of the prior art, when the output voltage VO decreases at an instantaneous interruption, the voltage of the second primary winding 122b decreases accordingly, and it is detected that the power supply voltage VCC reaches VCC(OFF), so that overload protection is enabled even though an overloaded state is not detected.

In a switching power supply circuit having the latch-type overload protection function of the prior art, a power supply is turned on again before a latched circuit is reset after an instantaneous interruption, so that overload protection is kept enabled. Thus the power supply is started in a stopped state at the instantaneous interruption and the power supply may fail to start.

On the other hand, in the case of a switching power supply circuit having the self-reset overload protection function of the prior art, unlike the latch-type circuit, the circuit can automatically recover from an overload protection state but overload protection is enabled by the same operation during an instantaneous interruption. Also in this case, the start of a power supply may be delayed because recovery to a normal operation requires a long time.

For example, in the prior art example, the switching element does not perform the switching operation until the predetermined number of counts of the timer circuit. During that time, power is not supplied from the input side to the load side and thus the restart of the power supply is delayed. For example, the restart takes about 1 second to 2 seconds and thus the power supply operation may become unstable.

### DISCLOSURE OF THE INVENTION

The present invention has been devised to solve the problem of the prior art. An object of the present invention is to provide a switching power supply which can reliably prevent a malfunction of overload protection from interrupting the start of a power supply or delaying the start of the power supply even at an instantaneous interruption such as a power failure, can stably restart the power supply, and can achieve a stable power supply operation.

In order to solve the problem, a switching power supply of the present invention in which an inductance component is charged with power supplied from an input side, as magnetic energy, by the switching operation of a switching element and the power is supplied from the inductance component to a load side based on the magnetic energy, the switching power supply including a control circuit for adjusting and controlling the switching operation of the switching element according to fluctuations in load, the control circuit including: an internal power supply circuit for supplying power to an internal circuit, an overload protection circuit for detecting an overloaded state and suppressing an amount of power supply to the load side, and an on time detection circuit for detecting an on time in the switching operation of the switching element, wherein when the on time detection circuit detects that the on time is at least a predetermined time, the overload protection circuit is not operated.

Thus it is possible to cancel an overload protection operation at an instantaneous interruption, thereby reliably preventing restart in a power supply stopped state caused by overload protection or preventing delayed restart.

Further, the on time detection circuit determines the maximum value of the on time.

Thus it is possible to determine the maximum on time of the switching element so as not to cause heat or a break in the power supply even in the event of an abnormality such as excessive power supply from the input side and an increased on time of the switching element as operations performed in a period other than an instantaneous interruption.

As has been discussed, the present invention makes it possible to detect an increase in the on time of the switching element at an instantaneous power shutdown (instantaneous interruption) such as a power failure, and cancel the overload protection operation when an increase in on time is detected.

It is therefore possible to reliably prevent a malfunction of overload protection from interrupting the start of the power supply or delaying the start of the power supply even at an instantaneous interruption such as a power failure, stably restart the power supply, and achieve a stable power supply operation.

### BRIEF DESCRIPTION OF THE DRAWINGS

FIG. 1 is a circuit diagram showing the configuration of a semiconductor device for controlling a switching power supply, in a switching power supply according to a first embodiment of the present invention;

FIG. 2 is a circuit diagram showing the configuration of the switching power supply of the first embodiment;

FIG. 3 is a circuit diagram showing another configuration (1) of the semiconductor device for controlling a switching power supply, in the switching power supply of the first embodiment;

FIG. 4 is a circuit diagram showing another configuration (2) of the semiconductor device for controlling a switching power supply, in the switching power supply of the first embodiment;

FIG. 5 is a circuit diagram showing the configuration of a semiconductor device for controlling a switching power supply, in a switching power supply according to a second embodiment of the present invention;

FIG. 6 is a circuit diagram showing another configuration (1) of the semiconductor device for controlling a switching power supply, in the switching power supply of the second embodiment;

FIG. 7 is a circuit diagram showing another configuration (2) of the semiconductor device for controlling a switching power supply, in the switching power supply of the second embodiment;

FIG. 8 is a timing chart showing operations in the switching power supply according to the embodiment of the present invention;

FIG. 9 is a circuit diagram showing the configuration of a semiconductor device for controlling a switching power supply with a latch-type overload protection function, in a switching power supply of the prior art;

FIG. 10 is an explanatory drawing showing a timing chart of a steady-state operation in the switching power supply of the prior art, for comparison with the present invention;

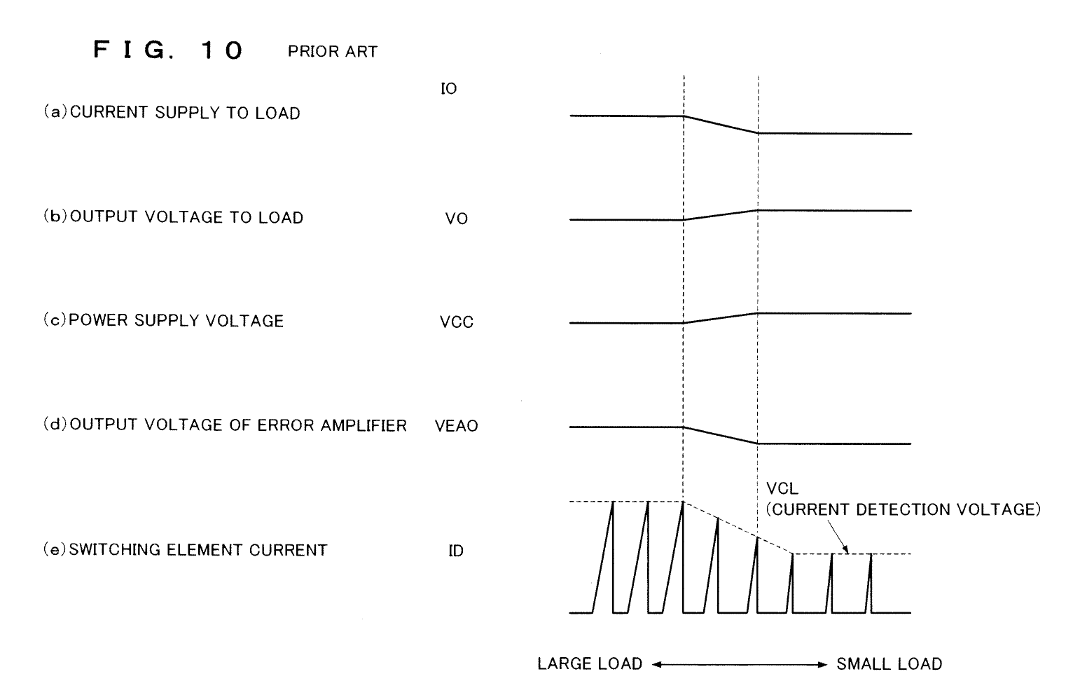

FIG. 11 is a timing chart of a latch-type overload protection operation in the switching power supply of the prior art;

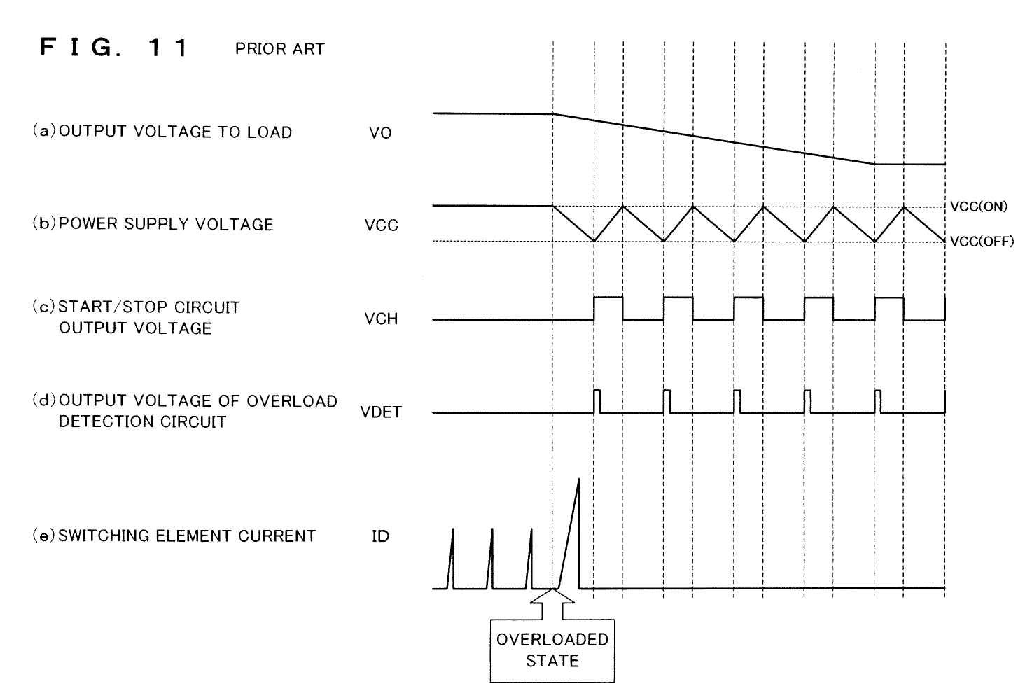

FIG. 12 is a circuit diagram showing the configuration of a semiconductor device for controlling a switching power supply with a self-reset overload protection function, in the switching power supply of the prior art; and

FIG. 13 is a timing chart showing operations in a self-reset overload protection operation of the switching power supply of the prior art.

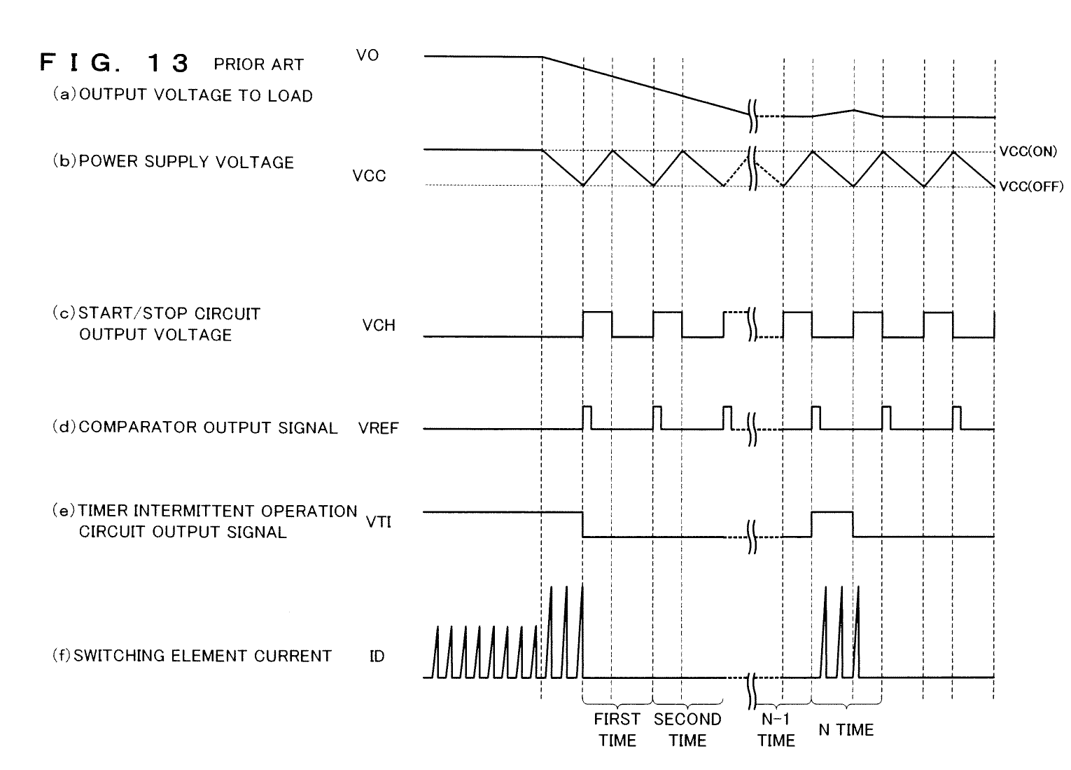

### DESCRIPTION OF THE EMBODIMENTS

A switching power supply representing embodiments of the present invention will be specifically described below in accordance with the accompanying drawings.

### First Embodiment

The following will discuss a switching power supply according to a first embodiment of the present invention.

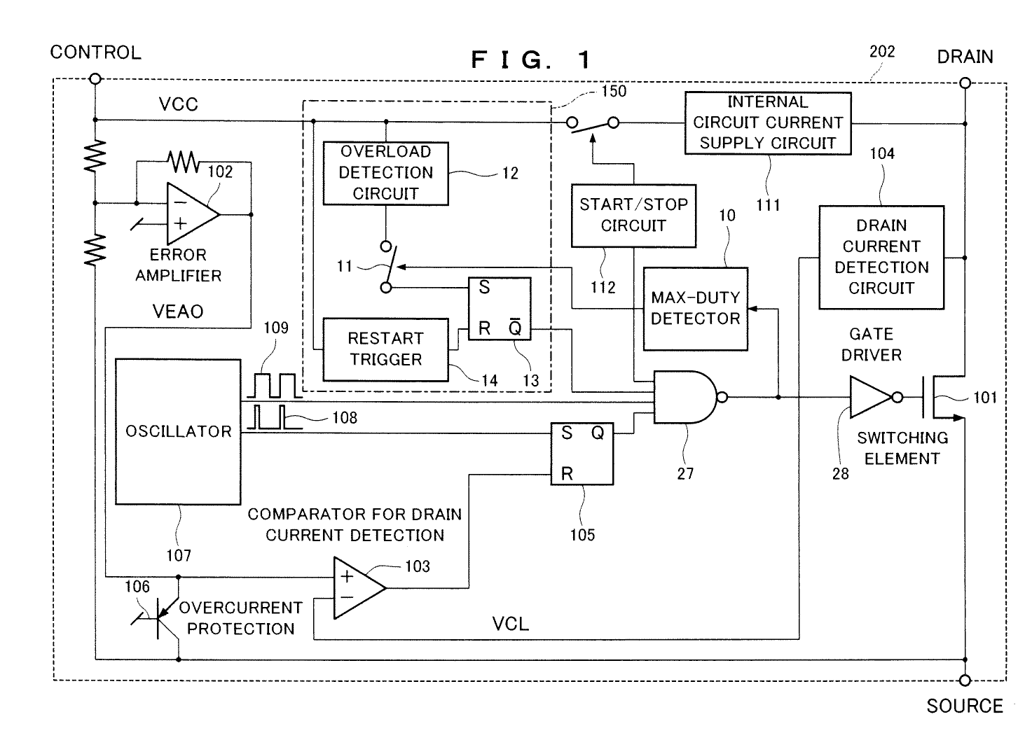

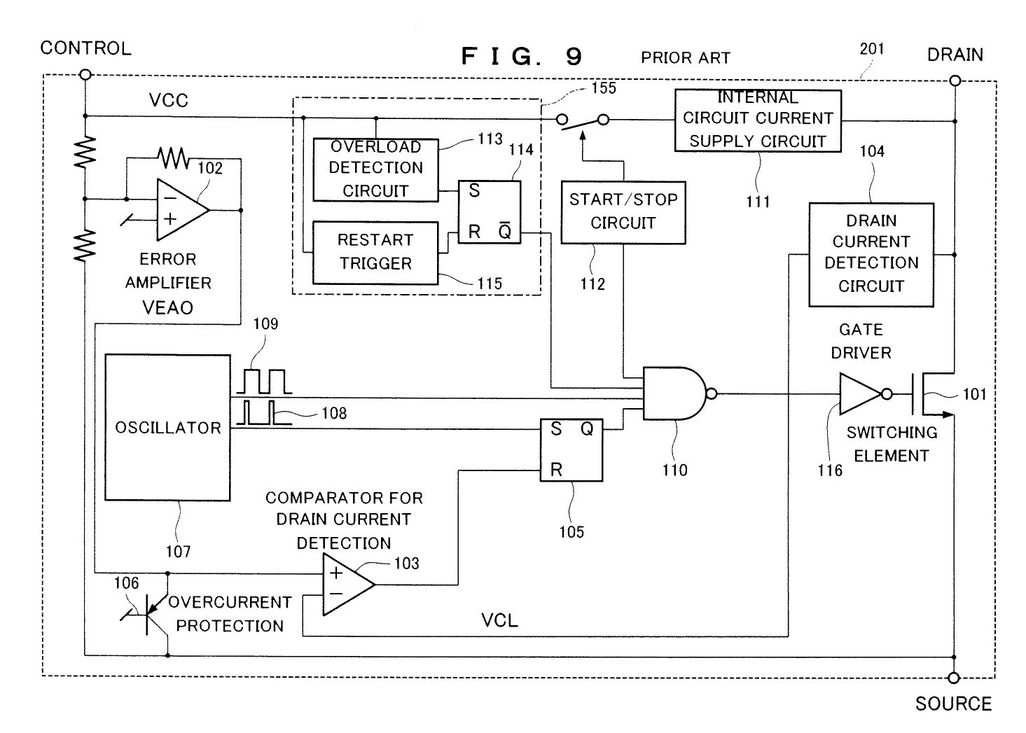

FIG. 1 is a circuit diagram showing a structural example of a semiconductor device for controlling a switching power supply, in the switching power supply of the first embodiment. In FIG. 1, the same constituent elements as in the semiconductor device for controlling the switching power supply according to the prior art of FIG. 9 are indicated by the same reference numerals and the explanation thereof is omitted.

A semiconductor device 202 for controlling a switching power supply in FIG. 1 includes a switching element 101 and a control circuit for controlling the switching operation of the switching element 101. In the control circuit, a MAX-DUTY detector 10 is disposed between the output part of a NAND circuit 27 and a drive circuit 28 to detect a ratio of an on time to the switching period of the switching element 101, that is, an on-duty cycle DON.

In an overload protection circuit 150, a switch 11 is disposed between the output part of an overload detection circuit 12 and the set terminal input part of a flip-flop circuit 13, which is a latched circuit for a switching operation stop circuit, such that the switch 11 is turned off by the MAX-DUTY detector 10 when the on-duty cycle DON is a maximum on-duty cycle DONmax. The switch 11 is also connected to the output part of the MAX-DUTY detector 10.

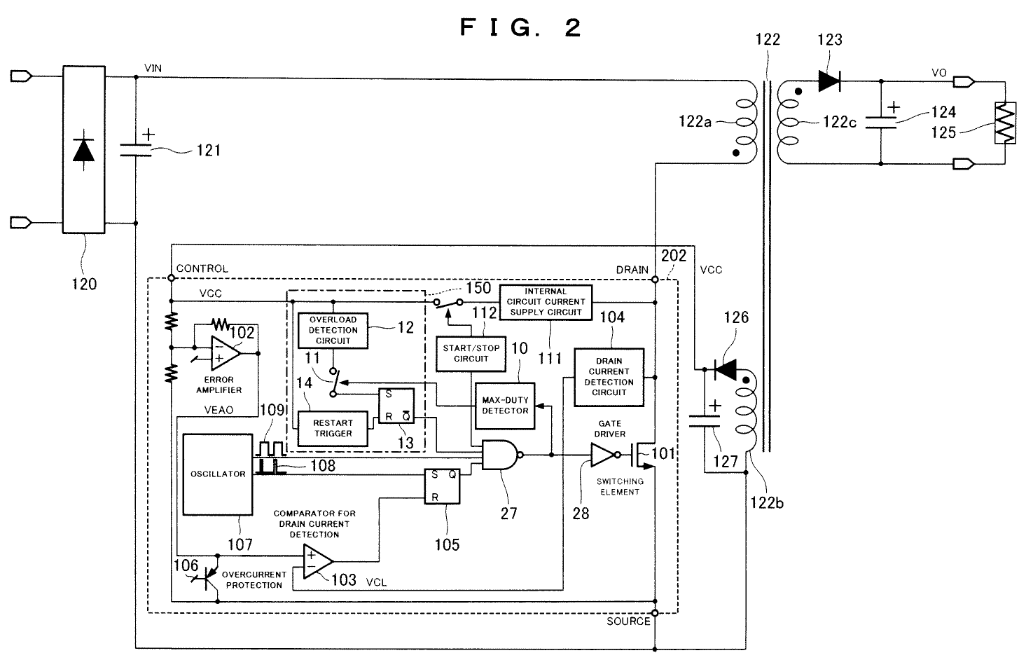

FIG. 2 is a circuit diagram showing an example of the switching power supply configured using the semiconductor device for controlling the switching power supply in FIG. 1. The switching power supply is different from the switching power supply of the prior art only in the semiconductor device 202 for controlling the switching power supply. Other configurations are similar to the configurations of the switching power supply of the prior art and thus the explanation thereof is omitted.

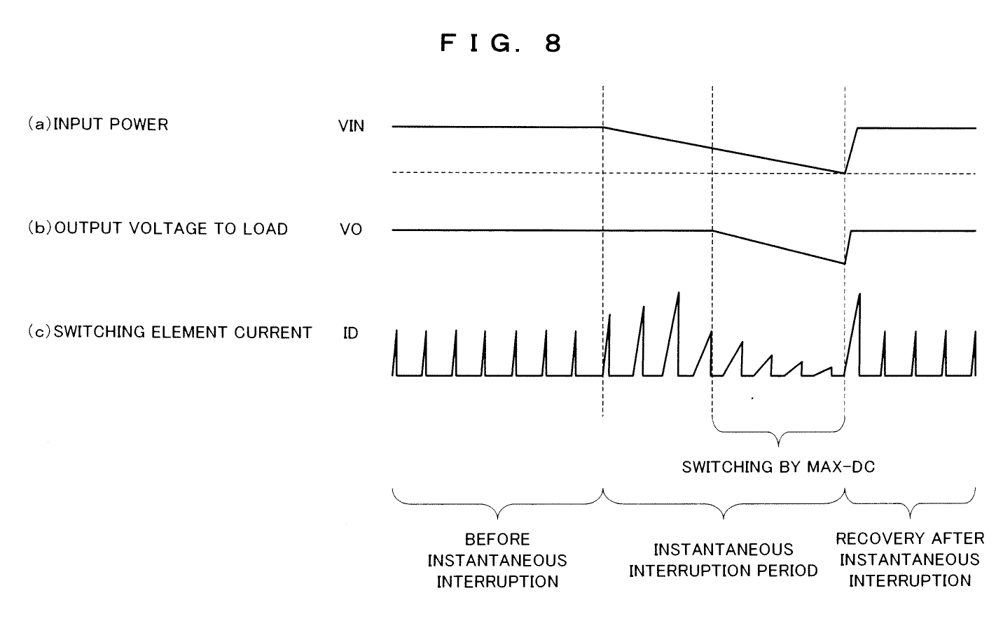

Referring to the timing chart of FIG. 8, the following will discuss operations at an instantaneous interruption in the switching power supply of the first embodiment. The operations at an instantaneous interruption are different from the operations of the switching power supply configured using the semiconductor device for controlling the switching power supply in FIG. 9 according to the prior art.

At an instantaneous interruption, power supply from an input side is instantaneously cut off and thus an input voltage VIN gradually decreases (FIG. 8(A)). Further, from when the input voltage VIN starts decreasing to when the input voltage VIN comes close to zero, power can be supplied from the input side to an output side. Thus an output voltage VO does not decrease for a while. In other words, immediately after the instantaneous interruption, the input voltage VIN decreases but the output voltage VO may not decrease.

In this state, the input voltage VIN decreases and the output voltage VO (∝ reflector voltage VOR) does not change. Thus the on-duty cycle DON gradually increases with a reduction in input voltage according to Formulas (1) and (2) and finally increases to the maximum on-duty cycle DONmax. Since the on duty cycle cannot have a value exceeding the maximum on-duty cycle thereafter, power required from a load side cannot be supplied and the output voltage VO starts gradually decreasing.

In the circuit configuration of the present embodiment, the MAX-DUTY detector 10 detects that the on-duty cycle DON reaches the maximum on-duty cycle DONmax, and the switch 11 is turned off in response to the output signal of the MAX-DUTY detector 10. Thus the RS flip-flop circuit 13 is not fed with a set signal from the overload detection circuit 12 and overload protection is disabled (FIGS. 8(B) and 8(C)).

As has been discussed, the MAX-DUTY detector 10 detects that the on-duty cycle DON has increased to DONmax at an instantaneous interruption, and then an overload protection operation is disabled. Thus it is possible to prevent a power supply from being restarted in a stopped state after an instantaneous interruption.

In this embodiment, the switch 11 is disposed on the output part of the overload detection circuit 12. The same effect can be obviously obtained also by disposing the switch 11 on the input part of the overload detection circuit 12.

In a typical power supply, a circuit for limiting the on-duty cycle DON within the maximum on-duty cycle DONmax is disposed to prevent heat and a break which are caused by excessive power supply from an input side and an increased on time of a switching element in the event of an abnormality, whereas in the present embodiment, the MAX-DUTY detector 10 acting as this circuit at an instantaneous interruption is used to prevent overload protection from being enabled at the instantaneous interruption as has been described.

This configuration is preferable because it is not particularly necessary to provide a circuit for detecting an on time at an instantaneous interruption, thereby reducing a circuit size. Another circuit for detecting an on time may be provided in addition to the MAX-DUTY detector 10.

The first embodiment has illustrated a PWM power supply circuit which increases or reduces an on duty width according to an output power. For example, the control system may be pulse-frequency-modulation (PFM) for changing a frequency according to power required by a load or may be a blocking oscillation control system for changing the number of times of switching, as long as an on time is increased by the control system when the input voltage VIN decreases at an instantaneous interruption.

The on-duty cycle is a ratio of an on time to the switching period of the switching element and the detection of the on-duty cycle is synonymous with the detection of an on time. Thus also in a self-excited power supply having an inconstant period, for example, as in a ringing-choke-converter (RCC) system, the same effect can be obtained by detecting an on time and disabling overload protection when the on time is at least a predetermined value.

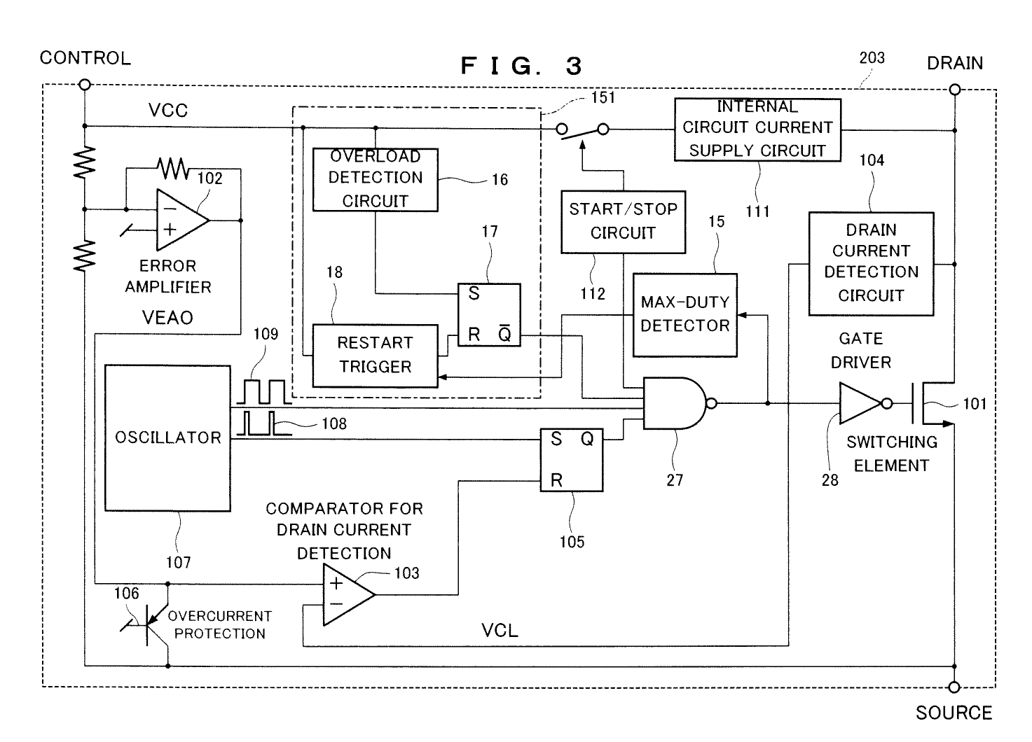

Moreover, the first embodiment illustrated that the switch 11 is provided between the overload detection circuit 12 and the RS flip-flop circuit 13 and the set signal is not outputted to the RS flip-flop circuit 13 at an instantaneous interruption. The same effect can be obtained by another method shown in FIG. 3 in which every time a MAX-DUTY detector 15 detects an on-duty cycle having reached DONmax, a restart trigger 18 in an overload protection circuit 151 of a semiconductor device 203 for controlling a switching power supply keeps inputting a reset signal to an RS flip-flop circuit 151 to always disable protection in a latched state.

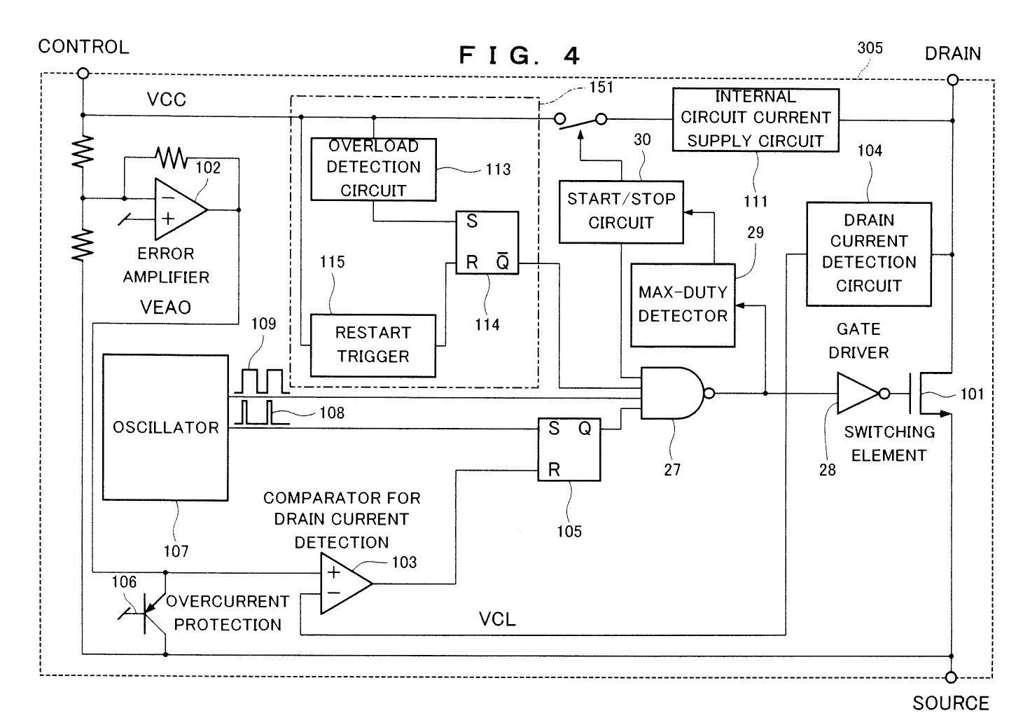

Further the first embodiment of FIG. 1 illustrated that the switch 11 is provided between the overload detection circuit 12 and the RS flip-flop circuit 13 and the set signal is not outputted to the RS flip-flop circuit 13 at an instantaneous interruption. The same effect as the first embodiment can be obtained by another method shown in FIG. 4 in which the output part of a MAX-DUTY detector 29 in a semiconductor device 305 for controlling a switching power supply is connected to a start/stop circuit 30, so that the following operations are realized:

In the configuration of FIG. 4, when the MAX-DUTY detector 29 detects the maximum on-duty cycle DONmax at an instantaneous interruption, a signal is outputted from the MAX-DUTY detector 29, and power is supplied from an internal circuit current supply circuit 111 to an internal circuit by the start/stop circuit 30, so that a power supply voltage VCC at the instantaneous interruption is not reduced to VCC(OFF) or lower.

Since the power supply voltage VCC is not reduced to VCC(OFF) at which overload protection is enabled, overload protection is not enabled at an instantaneous interruption and it is thus possible to prevent delayed restart of the power supply.

### Second Embodiment

The following will describe a switching power supply according to a second embodiment of the present invention.

When the power supply is not shifted to a timer intermittent operation of self-reset type at an instantaneous interruption, overload protection is enabled after the instantaneous interruption and it takes a long time to recover from a protecting operation, so that the start of the power supply is delayed. In the second embodiment, the delayed start can be avoided as follows:

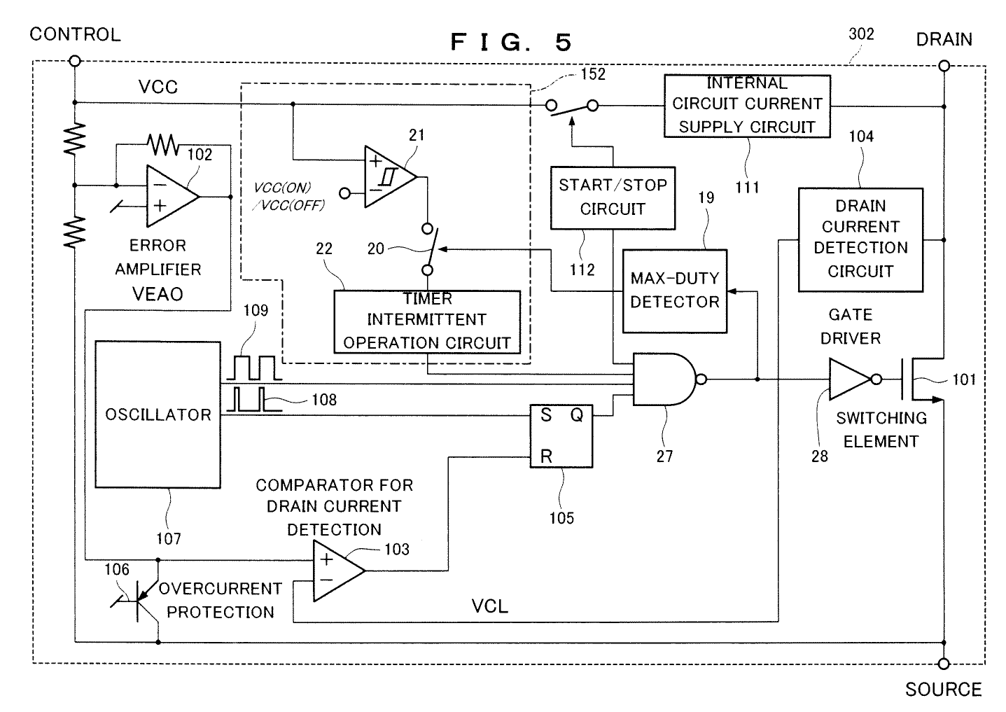

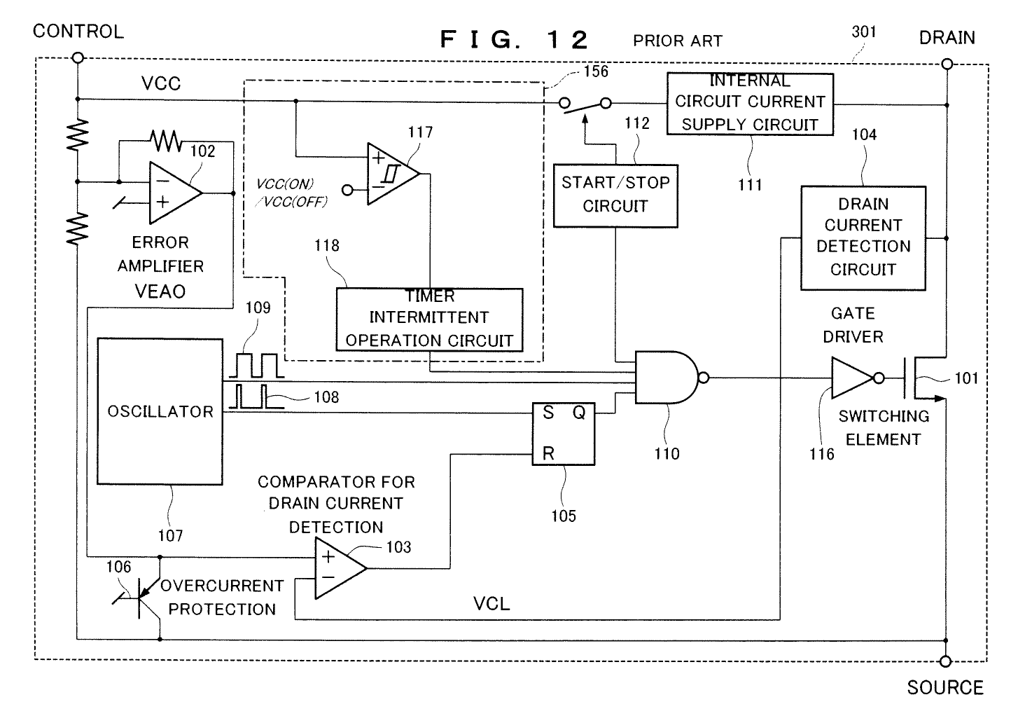

FIG. 5 is a circuit diagram showing a structural example of a semiconductor device for controlling a switching power supply, in the switching power supply of the second embodiment. In FIG. 5, the same constituent elements as in the semiconductor device for controlling the switching power supply according to the prior art of FIG. 12 are indicated by the same reference numerals and the explanation thereof is omitted.

A semiconductor device 302 for controlling a switching power supply in FIG. 5 includes a switching element 101 and a control circuit for controlling the switching operation of the switching element 101. In the control circuit, a MAX-DUTY detector 19 is connected between the output part of a NAND circuit 27 and a drive circuit 28 to detect a maximum on-duty cycle DONmax of the switching element 101.

In an overload protection circuit 152, a switch 20 is disposed between the output part of a comparator 21 and the input part of a timer intermittent operation circuit 22 for a switching operation stop circuit such that the switch 20 is turned off when an on-duty cycle DON increases to the maximum on-duty cycle DONmax, and the MAX-DUTY detector 19 is so connected as to turn on/off the switch 20.

As an example of the switching power supply of the present embodiment, the semiconductor device 302 for controlling the switching power supply in FIG. 5 replaces the semiconductor device 202 for controlling the switching power supply in the circuit diagram of the switching power supply shown in FIG. 2.

Regarding the operations of the switching power supply configured thus, operations at an instantaneous interruption are different from the operations of the switching power supply circuit having the self-reset overload protection function of the prior art shown in FIG. 12.

In other words, an input voltage VIN decreases at an instantaneous interruption and when the on-duty cycle DON reaches the maximum on-duty cycle DONmax, the switch 20 is turned off in response to a signal outputted from the MAX-DUTY detector 19. Thus in this state, a signal is not inputted to the timer intermittent operation circuit 22 and overload protection is disabled.

At this point, the input voltage VIN, an output voltage VO to a load, and a switching element current ID are similar to the timing chart of FIG. 8 illustrating operations at an instantaneous interruption according to the first embodiment.

The MAX-DUTY detector 19 detects that the on-duty cycle DON reaches DONmax at an instantaneous interruption and the overload protection function is disabled, thereby preventing the restart of a power supply from being delayed after the instantaneous interruption.

The second embodiment illustrated that the switch 20 is disposed between the output part of the comparator 21 and the input part of the timer intermittent operation circuit 22 for a switching operation stop circuit. The same effect can be obviously obtained also by disposing the switch 20 on the input part of the comparator 21.

In a typical power supply, a circuit for limiting the on-duty cycle DON within the maximum on-duty cycle DONmax is disposed to prevent heat and a break which are caused by excessive power supply from an input side and an increased on time of a switching element in the event of an abnormality, whereas in the present embodiment, the MAX-DUTY detector 19 acting as this circuit at an instantaneous interruption is used to prevent overload protection from being enabled at the instantaneous interruption as has been discussed.

This configuration is preferable because it is not particularly necessary to provide a circuit for detecting an on time at an instantaneous interruption, thereby reducing a circuit size. Another circuit for detecting an on time may be provided in addition to the MAX-DUTY detector 19.

The second embodiment has illustrated a PWM power supply circuit which increases or reduces an on duty width according to an output power. For example, the control system may be pulse-frequency-modulation (PFM) for changing a frequency according to power required by a load or may be a blocking oscillation control system for changing the number of times of switching, as long as an on time is increased by the control system when the input voltage VIN decreases at an instantaneous interruption.

The on-duty cycle is a ratio of an on time to the switching period of the switching element and the detection of the on-duty cycle is synonymous with the detection of an on time. Thus also in a self-excited power supply having an inconstant period, for example, as in a ringing-choke-converter (RCC) system, the same effect can be obtained by detecting an on time and disabling overload protection when the on time is at least a predetermined value.

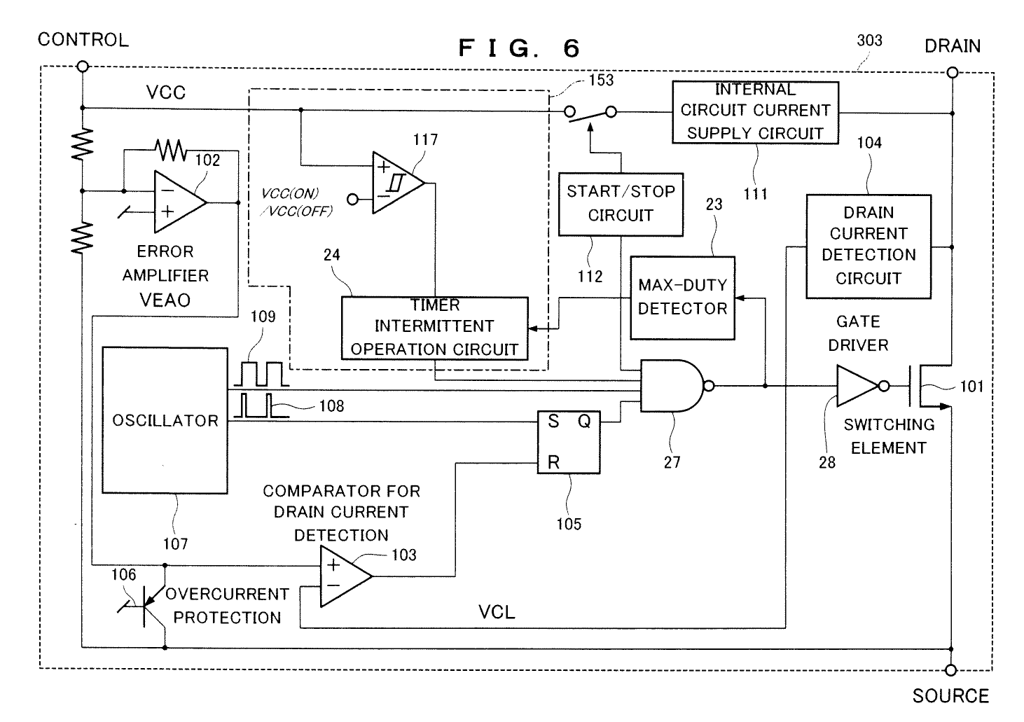

In the second embodiment of FIG. 5, the switch 20 is provided between the comparator 21 and the timer intermittent operation circuit 22 which compose the overload protection circuit 152 and overload protection by the timer intermittent operation circuit 22 is disabled when the MAX-DUTY detector 19 detects the maximum on-duty cycle DONmax. In another method shown in FIG. 6, a MAX-DUTY detector 23 in a semiconductor device 303 for controlling a switching power supply is connected to a timer intermittent operation circuit 24 composing an overload protection circuit 153, so that the MAX-DUTY detector 23 is operated to keep resetting the number of counts of the timer intermittent operation circuit 24 when the on-duty cycle reaches DONmax.

In a circuit having the self-reset overload protection function of the prior art, overload protection is enabled and thus the start of a power supply is delayed, whereas in the circuit configuration of the present embodiment, the switching element 101 always performs a switching operation in a period during which a power supply voltage VCC reaches a starting voltage VCC(ON) and decreases from VCC(ON) to VCC(OFF), thereby quickly starting the power supply after an instantaneous interruption.

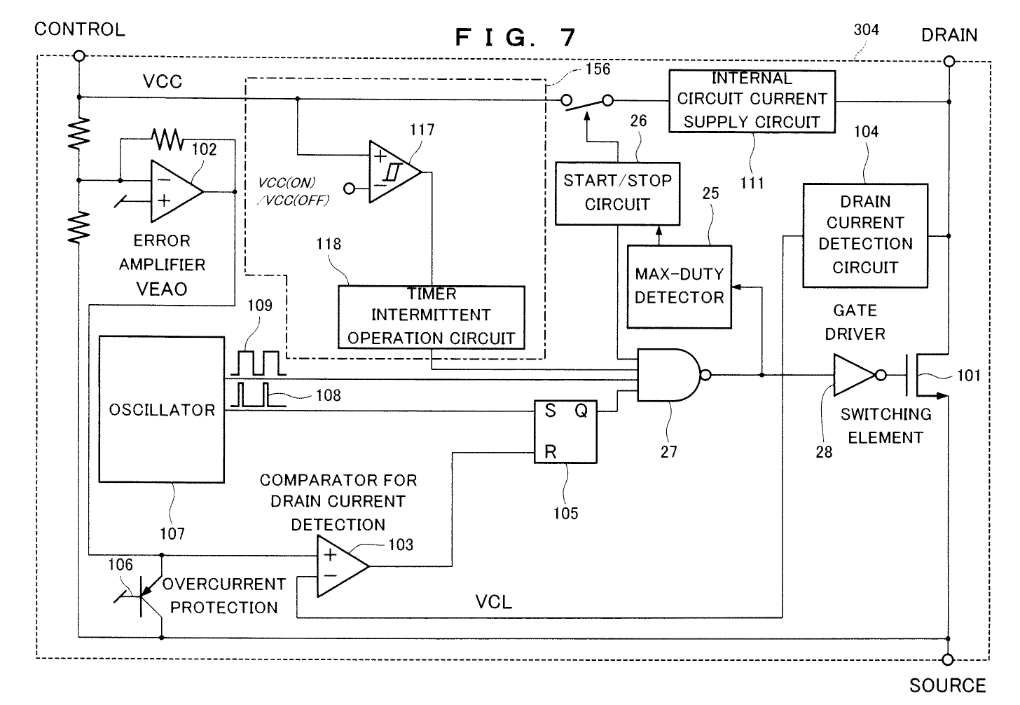

In the second embodiment of FIG. 5, the switch 20 is provided between the comparator 21 and the timer intermittent operation circuit 22 which compose the overload protection circuit 152 and overload protection by the timer intermittent operation circuit 22 is disabled when the MAX-DUTY detector 19 detects the maximum on-duty cycle DONmax. The same effect as the second embodiment can be obtained by another method shown in FIG. 7 in which the output part of a MAX-DUTY detector 25 in a semiconductor device 304 for controlling a switching power supply is connected to a start/stop circuit 26, so that the following operations can be realized:

According to the configuration of FIG. 7, when the MAX-DUTY detector 25 detects a maximum on-duty cycle DONmax at an instantaneous interruption, a signal is outputted from the MAX-DUTY detector 25 and power is supplied from an internal circuit current supply circuit 111 to an internal circuit by the start/stop circuit 26, so that a power supply voltage VCC at the instantaneous interruption is not reduced to VCC(OFF) or lower.

Since the power supply voltage VCC is not reduced to VCC(OFF) at which overload protection is enabled, overload protection is not enabled at an instantaneous interruption and thus it is possible to prevent delayed restart of the power supply.

The switching power supply of the present embodiment has been described based on a control system in which the output voltage VO is detected by the power supply voltage VCC of the semiconductor device for controlling the switching power supply and the switching operation is controlled to stabilize the output voltage at a predetermined voltage. Other general control systems may be used in which the output voltage VO is detected by a shunt regulator or a Zener diode and is fed back using a photocoupler and the like.

What is claimed is:

1. A switching power supply in which an inductance component is charged with power supplied from an input side, as magnetic energy, by a switching operation of a switching element and the power is supplied from the inductance component to a load side based on the magnetic energy,
the switching power supply comprising a control circuit for adjusting and controlling the switching operation of the switching element according to fluctuations in load,
the control circuit, comprising:
an internal power supply circuit for supplying power to an internal circuit,
an overload protection circuit for detecting an overloaded state and suppressing an amount of power supply to the load side, and
an on time detection circuit for detecting an on time in the switching operation of the switching element,
wherein when the on time detection circuit detects that the on time is at least a predetermined time, the overload protection circuit is not operated.

2. The switching power supply according to claim 1, wherein the on time detection circuit determines a maximum value of the on time.

3. The switching power supply according to claim 1, wherein the switching element has a switching frequency fixed at a constant frequency.

4. The switching power supply according to claim 1, wherein the overload protection circuit at least comprises:
an overload detection circuit for detecting the overloaded state; and
a switching operation stop circuit for stopping or suppressing the switching operation of the switching element when the overload detection circuit detects the overloaded state.

5. The switching power supply according to claim 4, wherein the overload protection circuit has the overload detection circuit and the switching operation stop circuit connected to each other via a switch, and
the switch is turned off when the on time detection circuit detects that the on time is at least the predetermined time.

6. The switching power supply according to claim 4, wherein in the overload protection circuit,
the switching operation stop circuit has a resetting device,
the on time detection circuit is connected to the resetting device, and
the resetting device continuously resets the switching operation stop circuit when the on time detection circuit detects that the on time is at least the predetermined time.

7. The switching power supply according to claim 6, wherein in the overload protection circuit,
the overload detection circuit has a control circuit voltage detector for detecting a power supply voltage of the control circuit, and
the switching operation stop circuit is operated when the control circuit voltage detector detects that the power supply voltage has decreased.

8. The switching power supply according to claim 7, wherein in the overload protection circuit,
the on time detection circuit is connected to the internal power supply circuit instead of the resetting device, and
when the on time detection circuit detects that the on time is at least the predetermined time,
power is supplied from the internal power supply circuit to the control circuit, and
the control circuit voltage detector does not operate the switching operation stop circuit.

9. The switching power supply according to claim 1, wherein in the overload protection circuit,
the switching operation stop circuit is configured using a latched circuit.

10. The switching power supply according to claim 1, wherein in the overload protection circuit,
the switching operation stop circuit comprises a controller for causing the switching element to intermittently perform the switching operation.
